(19) United States
(12) Patent Application Publication
(10) Pub. No.: US 2026/0187260 A1
(43) Pub. Date: Jul. 2, 2026

(54) MECHANISM TO LIMIT OUT-OF-COMPLIANCE INTRA-DIE COMMUNICATION

(71) Applicant: Intel Corporation, Santa Clara, CA (US)

(72) Inventors: Ruben Daniel VARELA VELASCO, Portland, OR (US); Boris DOLGUNOV, San Jose, CA (US); David DEITCHER, Jerusalem (IL)

(73) Assignee: Intel Corporation, Santa Clara, CA (US)

(21) Appl. No.: 19/004,300

(22) Filed: Dec. 28, 2024

(51) Int. Cl. G06F 21/60

(52) U.S. Cl. CPC G06F 21/606; G06F 21/604

(57) ABSTRACT

An apparatus, method and system to implement a mechanism to limit out-of-compliance intra-die communication. A receiver receives a packet directed to a component on a die or a package containing the die. A logic circuit evaluates attributes of the packet based on a number of criteria and a privilege level associated with the component that is a target of the packet, wherein the logic circuit is to: when the attributes of the packet meet the number of criteria, evaluate a packet privilege level to access the component to the privilege level associated with the component and grant, substitute or downgrade the packet privilege level to access the component; and when one or more attributes of the packet does not meet the number of criteria, reject the packet.

### BACKGROUND

In typical two or more die configurations there is usually requirements to communicate between different dies that reside in different packages, often by physically sending data over an untrusted medium (e.g., motherboard). Thus, this untrusted medium can permit an additional attack surface from a security perspective when an attacker can modify, observe, and/or inject custom crafted packets to invade the die or package via the untrusted medium. Accordingly, mitigation is needed to verify or limit such out-of-specification information packets that can impact security. Furthermore, such complex architecture significantly increases the risk of attack when such data packets arrive at their destination with elevated privilege levels. Accordingly, an access control needs to be enforced so that an elevation of privilege at the die can be avoided.

### BRIEF DESCRIPTION OF DRAWINGS

Various examples in accordance with the present disclosure will be described with reference to the drawings, in which:

FIG. 1 illustrates a system having a die or package communicating with another die or package over a packet transfer fabric in which packet security check is imposed on incoming packet traffic at each die or package according to some examples of the disclosure.

FIG. 2 illustrates a packet security check logic operating on a received packet at the die or package of FIG. 1, before routing the packet to a component of the die or package according to some examples of the disclosure.

FIG. 3 shows a flow chart illustrating a method of operation on a received packet to provide packet security check according to some examples of the disclosure.

FIGS. 4(A)-4(B) show a flow chart illustrating another method of operation on a received packet to provide packet security check according to some examples of the disclosure.

FIG. 5 illustrates an example packet that is operated on by the packet security check according to some examples of the disclosure.

FIG. 6 illustrates another example packet that is operated on by the packet security check according to some examples of the disclosure.

FIG. 7 illustrates an example computing system.

FIG. 8 illustrates a block diagram of an example processor and/or System on a Chip (SoC) that may have one or more cores and an integrated memory controller.

FIG. 9 is a block diagram illustrating a computing system 900 configured to implement one or more aspects of the examples described herein.

FIG. 10(A) is a block diagram illustrating both an example in-order pipeline and an example register renaming, out-of-order issue/execution pipeline according to examples.

FIG. 10(B) is a block diagram illustrating both an example in-order architecture core and an example register renaming, out-of-order issue/execution architecture core to be included in a processor according to examples.

FIG. 11 illustrates examples of execution unit(s) circuitry.

FIG. 12 is a block diagram of a register architecture according to some examples.

FIG. 13 illustrates examples of an instruction format.

FIG. 14 illustrates examples of an addressing information field.

### DETAILED DESCRIPTION

The present disclosure relates to methods, apparatus and systems for a mechanism to limit out-of-compliance intra-die communication. According to some examples, the disclosure describes a mechanism to parse and verify each incoming data packet over an intra-die or intra-package packet transfer fabric and apply rules to prevent incursion by out-of-compliance and/or malicious packets.

Some of the rules applied are:
If the packet is not routable according to hardware rules, the packet is rejected or remapped.
If the packet is routable but not expected (e.g., unsolicited response) the packet is rejected.
If the packet is expected, a few fields in the data packet can be hardcoded and rewritten to force in-the-specification compliance.

The mechanism described herein enforces compliance of sideband (SB) communication of a communication protocol across different dies and packages, avoiding privilege escalation or unexpected responses that can lead to security and functional issues. The described solution was developed as response to simple hardware attacks via intra-die communication.

With a Central Processing Unit (CPU)+Platform Controller Hub (PCH) architecture, or a System on Chip (SOC)+PCH architecture, there is a main die-to-die or package-to-package communication media that is susceptible to simple physical attacks. These attacks can access secure components on a die or package and, if malicious, can perform out-of-specification transactions. For example, debug transactions can be used to signal the SOC to enact debug activities without having the appropriate authentication for the SOC. Privilege levels can be changed to compromise some components. Many more examples abound for unauthorized actions once a die/package is compromised. The disclosure describes a solution at a beginning of a packet inflow at a die/package to prevent such unauthorized packet access. The disclosure describes a die, but the concept can be readily applied to a package tat contains a die or dice.

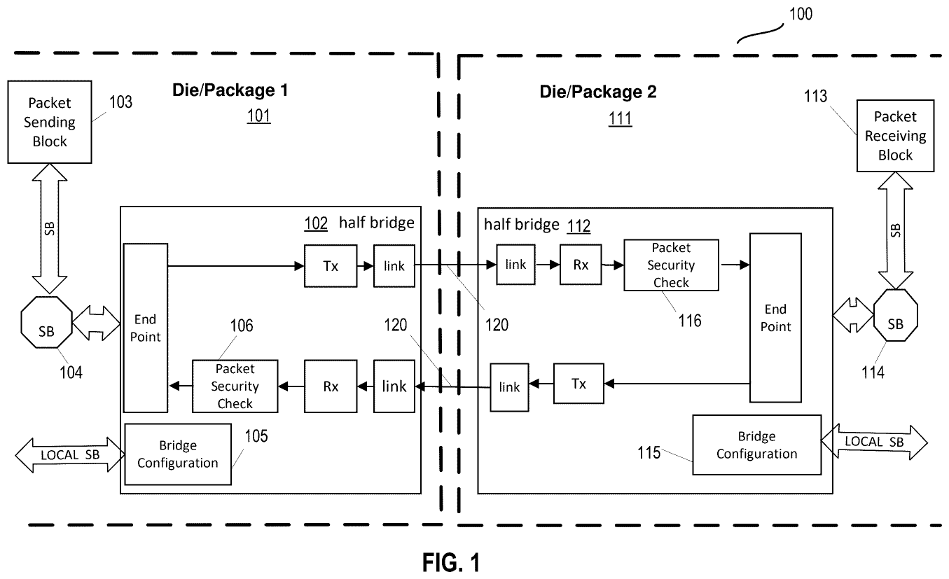

FIG. 1 illustrates a system having a die or package communicating with another die or package over a packet transfer fabric in which packet security check is imposed on incoming packet traffic at each die or package according to some examples of the disclosure. FIG. 1 shows a system 100 having a die (or package) 101 operating as a sender of a packet and a die (or package) 111 operating as a recipient of the packet. A packet sending block 103 routes the packet via a bus (SB) and a router (or switch) 104 to a half bridge 102, which operates as a transmit (Tx)/receive (Rx) interface coupled to a packet transfer fabric 120. The half bridge 102 may also include a bridge configuration logic 105 for configuring the half bridge. A packet security logic 106 is located in the receive flow within the half bridge 102.

The die 111 contains the other half of the bridge, where half bridge 112 connects to the half bridge 102 via the packet transfer fabric 120. The die 111 is shown as a recipient of the packet, in which the packet is intended to be routed to a packet receiving block 113 via a router (or switch) 114. A bridge configuration logic 115 and a packet security logic 116 are also present in the half bridge 112. The half bridges 102 and 112 are bi-directional so that both die 101 and die 111 can transmit and receive packets. It is to be noted that other structures, other than the system 100, can be implemented as well. FIG. 1 is shown as an example system.

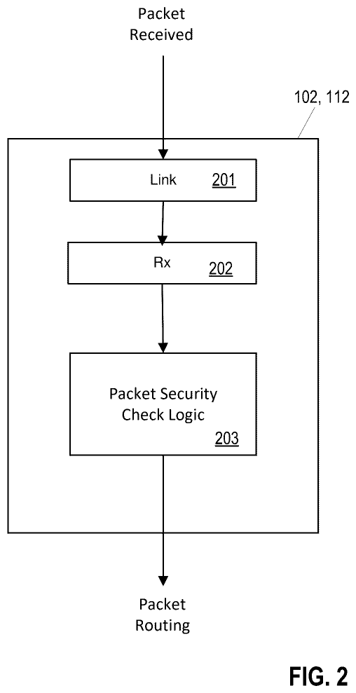

The component that provides the various examples described herein is implemented by the packet security check logic 106 or 116 when a packet is incoming from the packet transfer fabric 120. FIG. 2 shows an incoming packet from the packet transfer fabric 120 at a fabric link 201 and received by a receiver 202. This packet is routed to a packet security check logic 203. The packet security check logic 203 corresponds to the same named packet security check logic 106 or 116 of FIG. 1. Since the receiving die cannot know with certainty that the incoming packet is from the intended sender (other die in FIG. 1), a function of the packet security check logic 203 is to evaluate (e.g., test) the packet to determine if it is intended or not (e.g., attack). Thus, packet security check logic 203 can perform a number of tests to evaluate attributes of the packet based on a number of criteria and a privilege level associated with the incoming packet to access components on the die.

Detailed below are a number of items that the packet security check logic 203 can perform on the incoming packet according to some examples. Some example systems may implement only some, not all, of the listed tests.

Force compliance cases:

A response should only be seen, when it is solicited. The packet security check logic 203 can verify that there are outstanding requests to accept an incoming response. If the response is not solicited, the packet can be dropped (e.g., rejected). There are fields with special meaning in the incoming transactions that define the hardware behavior for the next double-word (DW) in the packet. The packet security check logic 203 can overwrite these fields ignoring the actual incoming transaction values to match the expectation. Access control can be correctly applied by a correct parsing of the newly/potentially corrected transaction, avoiding any undefined behavior by receiving mixed signals. There may be a special field in the incoming packet that defines the privilege of the transaction and this can be used to grant/deny access to certain assets. This is called Security Attributes of Initiator (SAI) and the receiving logic can filter and allow only SAIs that don't grant additional access to assets (components of the die) that should be protected against simple physical attacker (e.g., simple physical attacker can only get access to the intended assets).

Detailed implementation examples of the packet security check logic 203 that can be implemented:

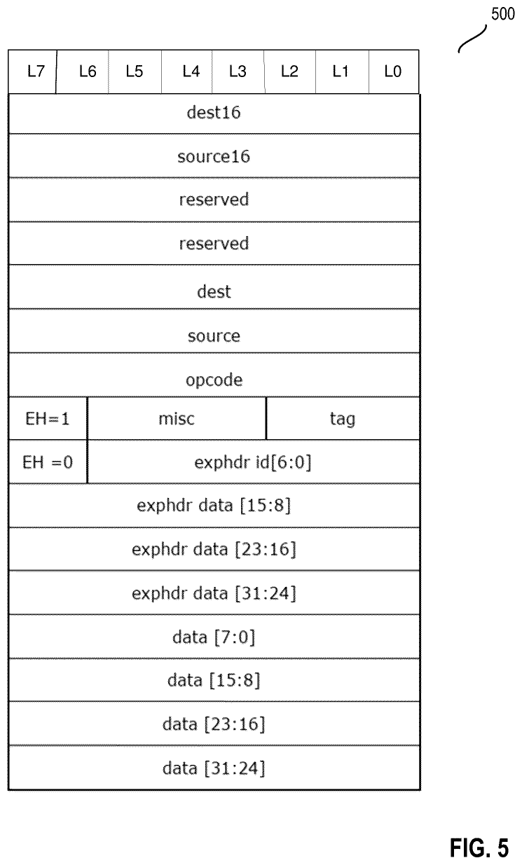

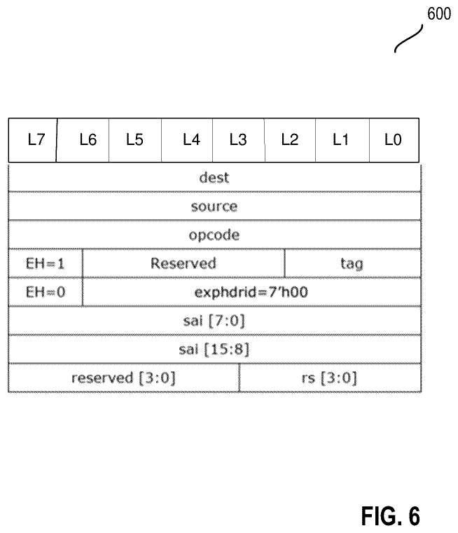

FIG. 5 illustrates an example packet 500 that is operated on by the packet security check according to some examples of the disclosure. FIG. 6 illustrates another example packet 600 that is operated on by the packet security check according to some examples of the disclosure. For the description below, FIG. 5 and FIG. 6 can be viewed for some of the nomenclature of packet fields described below.

The packet security check logic 203 can enforce destination and source mapping when allowed or remap the destination and/or source if necessary (e.g., substitute for an appropriate internal port number), and wait for the next DW. If the received DW is an expanded header, it can rewrite the first byte to 0×0, so the next DW is treated as data and proceed to SAI filtering. Or alternatively drop this transaction.

If the transaction is a completion (e.g., a response from a previous request) the parsing logic can verify that there are pending ongoing requests for that destination and allow the transaction, else transaction can be sent to error handler.

A filter can process SAI of incoming transaction in two stages:
1. First stage: Specific SAI substitution. List of hardcoded SAIs can be mapped to another predefined SAI. This substitution can be hardcoded in the filter and cannot be updated by design in some examples. Note that if an outside agent did acquire permission to do such an operation, the agent could escalate its privilege to hardware or debug levels that are not permitted to software.
2. SAI filtering stage: 256 bits SAI register can define SAI that should be filtered. When SAI of incoming transaction if filtered, the filter can replace incoming SAI with “DEVICE_UNTRUSTED_SAI” and can allow this transaction to path through. This operation downgrades the privilege level that will be granted to transaction at destination. “DEVICE_UNTRUSTED_SAI” is lowest privilege that can be on the Side band.

Additional filtering capabilities can include:
Dropping transactions undefined field values such as SAI Extended Header Identity (EHID). For example, only single EH with EHID=0 is allowed.
Filtering specific opcodes that may potentially cause incorrect behavior, such as for example bulk read/write.
Detection of First-In, First-Out (FIFOS) packet overflow.
Responsibility to track outgoing/incoming transactions and their responses.

As noted, the above text describe various rules and tests that can be performed to evaluate and accept, modify, or reject incoming packets. Not all of these test need to be implemented. Different schemes can apply different tests. Therefore, in a broad context, the packet security check logic 203 can evaluate attributes of the packet based on a number of criteria and a privilege level associated with the component that is a target of the packet, wherein the logic circuit is to: when the attributes of the packet meet the number of criteria, evaluate a packet privilege level to access the component to the privilege level associated with the component and grant, substitute or downgrade the packet privilege level to access the component; and when one or more attributes of the packet does not meet the number of criteria, reject the packet.

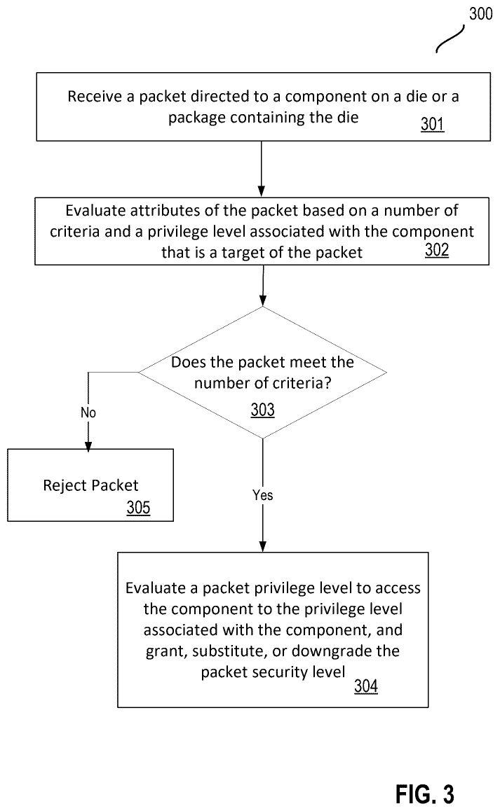

FIG. 3 shows a flow chart illustrating a method of operation on a received packet to provide packet security check according to some examples of the disclosure. FIG. 3 shows a method 300 that can be performed by an apparatus, processor and/or logic, such as the packet security check logic 203. At operation 301, packet security check logic 203 receives a packet directed to a component on a die or a package containing the die. At operation 302, packet security check logic 203 evaluates attributes of the packet based on a number of criteria and a privilege level associated with the component that is a target of the packet. At operation 303, if the packet does not meet the number of criteria, the packet is rejected at operation 305. If the packet meets the number of criteria, packet security check logic 203, at operation 304, evaluates the packet privilege level associated with the component and grants, substitutes or downgrades the packet privilege level.

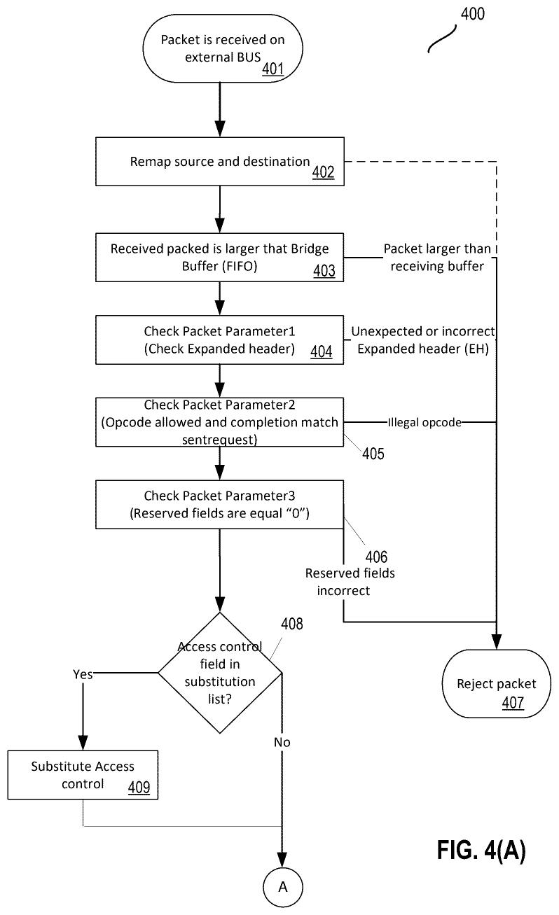

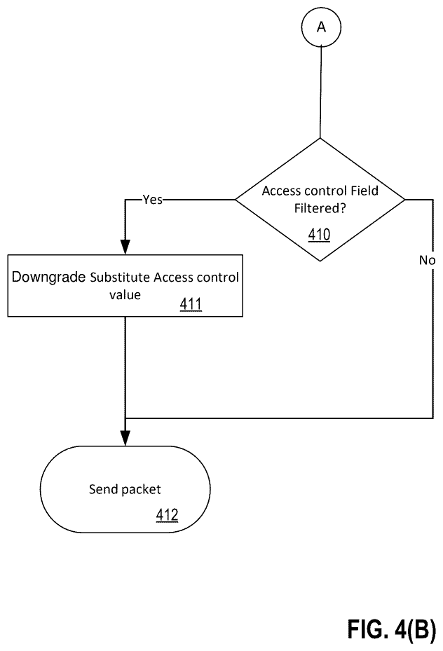

FIGS. 4(A)-4(B) show a flow chart illustrating another method of operation on a received packet to provide packet security check according to some examples of the disclosure. Note that FIGS. 4(A)-4(B) form one drawing and referred to simply as FIG. 4. FIG. 5 and FIG. 6 can be viewed together with FIG. 4 for examples of a packet. Some of the various tests described earlier in the disclosure can be applied in the flow diagram 400 of FIG. 4.

FIG. 4 shows a flow chart 400, where a packet is received on an external bus, such as the packet transfer fabric 120, at operation 401. At operation 402, the packet security check logic 203 allows the source and/or destination or enforce a remapping of the source and/or destination (e.g., change of ports). Alternatively, the packet can be rejected. At operation 403, if the packet is larger than the bridge FIFO buffer, the packet is rejected. At operation 404, the expanded header (EH) is checked. If the expanded header does not meet the set test (e.g., unexpected or incorrect EH), then the packet is rejected. At operation 406, the opcode is checked to determine if it is allowed or, if a completion packet, if it matches the sent request. If not accepted (e.g., illegal), the packet is rejected. At operation 406, the reserve fields are checked to determine if the reserved fields are all zero. If not, the packet is rejected. The rejected packets are dropped at operation 407.

For the privilege level check of the packet, at operation 408, the packet privilege level is evaluated to determine if the access control field (e.g., privilege level) is listed in a list, table, etc. If listed, then the access control is substituted to provide a substitute access at operation 409. Whether substituted or not, the evaluation progresses to operation 410 where the privilege level is checked to determine if the access control field is filtered. If filtered, the access control value is first downgraded at operation 411. The packet is then routed to the intended or re-routed destination (operation 412) with possible substituted or downgraded security access levels. Some examples may implement various other evaluation test and security modifications.

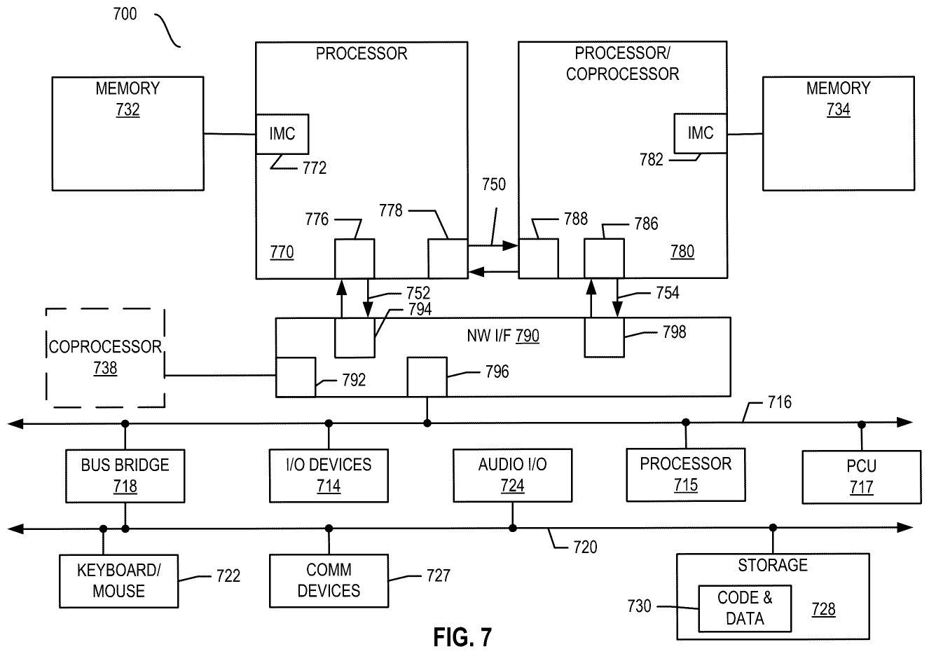

Although the disclosure describes some examples above in way of an apparatus method and system, other techniques can implement the same or equivalent techniques described. In some examples, the described packet security check logic 203 can be implemented in a processor architecture described in FIG. 7-FIG. 14.

### Example Systems

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example multiprocessor system 700 is shown to have two processors, the system may have three or more processors, or may be a single processor system. In some examples, the computing system is a system on a chip (SoC).

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a co-processor 738 via an interface circuit 792. In some examples, the co-processor 738 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator,, a data streaming accelerator, data graph operations, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730 and may implement the storage ISAB03 in some examples. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

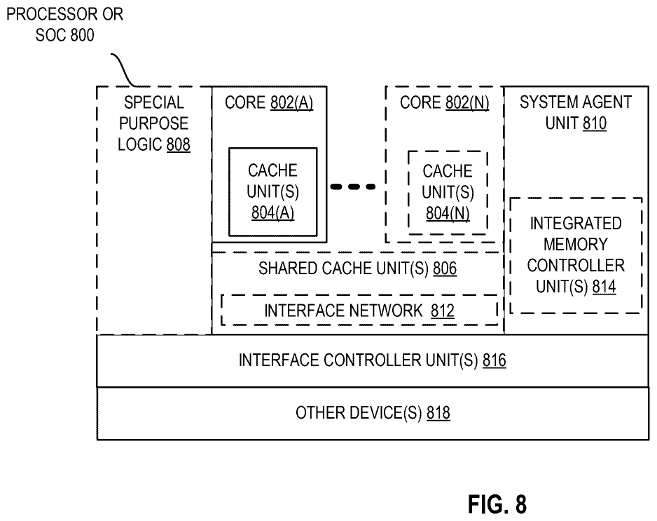

FIG. 8 illustrates a block diagram of an example processor and/or SoC 800 that may have one or more cores and an integrated memory controller. The solid lined boxes illustrate a processor and/or SoC 800 with a single core 802(A), system agent unit circuitry 810, and a set of one or more interface controller unit(s) circuitry 816, while the optional addition of the dashed lined boxes illustrates an alternative processor and/or SoC 800 with multiple cores 802(A)-(N), a set of one or more integrated memory controller unit(s) circuitry 814 in the system agent unit circuitry 810, and special purpose logic 808, as well as a set of one or more interface controller unit(s) circuitry 816. Note that the processor and/or SoC 800 may be one of the processors 770 or 780, or co-processor 738 or 715 of FIG. 7.

Thus, different implementations of the processor and/or SoC 800 may include: 1) a CPU with the special purpose logic 808 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 802(A)-(N) being one or more general purpose cores (e.g., general purpose in-order cores, general purpose out-of-order cores, or a combination of the two); 2) a co-processor with the cores 802(A)-(N) being a large number of special purpose cores intended primarily for graphics and/or scientific (throughput); and 3) a co-processor with the cores 802(A)-(N) being a large number of general purpose in-order cores. Thus, the processor and/or SoC 800 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller unit(s) circuitry 816 couple the cores 802(A)-(N) to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

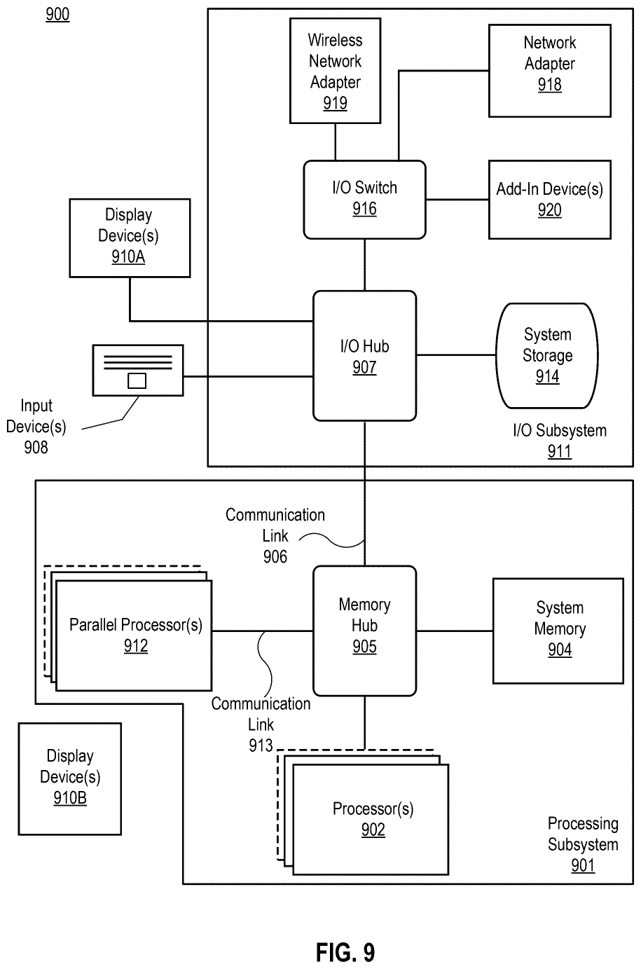

FIG. 9 is a block diagram illustrating a computing system 900 configured to implement one or more aspects of the examples described herein. The computing system 900 includes a processing subsystem 901 having one or more processor(s) 902 and a system memory 904 communicating via an interconnection path that may include a memory hub 905. The memory hub 905 may be a separate component within a chipset component or may be integrated within the one or more processor(s) 902. The memory hub 905 couples with an I/O subsystem 911 via a communication link 906. The I/O subsystem 911 includes an I/O hub 907 that can enable the computing system 900 to receive input from one or more input device(s) 908. Additionally, the I/O hub 907 can enable a display controller, which may be included in the one or more processor(s) 902, to provide outputs to one or more display device(s) 910A. In some examples the one or more display device(s) 910A coupled with the I/O hub 907 can include a local, internal, or embedded display device.

The processing subsystem 901, for example, includes one or more parallel processor(s) 912 coupled to memory hub 905 via a bus or communication link 913. The communication link 913 may be one of any number of standards-based communication link technologies or protocols, such as, but not limited to PCI Express, or may be a vendor specific communications interface or communications fabric. The one or more parallel processor(s) 912 may form a computationally focused parallel or vector processing system that can include a large number of processing cores and/or processing clusters, such as a many integrated core (MIC) processor. For example, the one or more parallel processor(s) 912 form a graphics processing subsystem that can output pixels to one of the one or more display device(s) 910A coupled via the I/O hub 907. The one or more parallel processor(s) 912 can also include a display controller and display interface (not shown) to enable a direct connection to one or more display device(s) 910B.

Within the I/O subsystem 911, a system storage unit 914 can connect to the I/O hub 907 to provide a storage mechanism for the computing system 900. An I/O switch 916 can be used to provide an interface mechanism to enable connections between the I/O hub 907 and other components, such as a network adapter 918 and/or wireless network adapter 919 that may be integrated into the platform, and various other devices that can be added via one or more add-in device(s) 920. The add-in device(s) 920 may also include, for example, one or more external graphics processor devices, graphics cards, and/or compute accelerators. The network adapter 918 can be an Ethernet adapter or another wired network adapter. The wireless network adapter 919 can include one or more of a Wi-Fi, Bluetooth, near field communication (NFC), or other network device that includes one or more wireless radios.

The computing system 900 can include other components not explicitly shown, including USB or other port connections, optical storage drives, video capture devices, and the like, which may also be connected to the I/O hub 907. Communication paths interconnecting the various components in FIG. 9 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 912 may incorporate circuitry optimized for graphics and video processing, including, for example, video output circuitry, and constitutes a graphics processing unit (GPU). Alternatively or additionally, the one or more parallel processor(s) 912 can incorporate circuitry optimized for general purpose processing, while preserving the underlying computational architecture, described in greater detail herein. Components of the computing system 900 may be integrated with one or more other system elements on a single integrated circuit. For example, the one or more parallel processor(s) 912, memory hub 905, processor(s) 902, and I/O hub 907 can be integrated into a system on chip (SoC) integrated circuit. Alternatively, the components of the computing system 900 can be integrated into a single package to form a system in package (SIP) configuration. In some examples at least a portion of the components of the computing system 900 can be integrated into a multi-chip module (MCM), which can be interconnected with other multi-chip modules into a modular computing system.

It will be appreciated that the computing system 900 shown herein is illustrative and that variations and modifications are possible. The connection topology, including the number and arrangement of bridges, the number of processor(s) 902, and the number of parallel processor(s) 912, may be modified as desired. For instance, system memory 904 can be connected to the processor(s) 902 directly rather than through a bridge, while other devices communicate with system memory 904 via the memory hub 905 and the processor(s) 902. In other alternative topologies, the parallel processor(s) 912 are connected to the I/O hub 907 or directly to one of the one or more processor(s) 902, rather than to the memory hub 905. In other examples, the I/O hub 907 and memory hub 905 may be integrated into a single chip. It is also possible that two or more sets of processor(s) 902 are attached via multiple sockets, which can couple with two or more instances of the parallel processor(s) 912.

Some of the particular components shown herein are optional and may not be included in all implementations of the computing system 900. For example, any number of add-in cards or peripherals may be supported, or some components may be eliminated. Furthermore, some architectures may use different terminology for components similar to those illustrated in FIG. 9. For example, the memory hub 905 may be referred to as a Northbridge in some architectures, while the I/O hub 907 may be referred to as a Southbridge.

### Example Core Architectures—In-Order and Out-of-Order Core Block Diagram

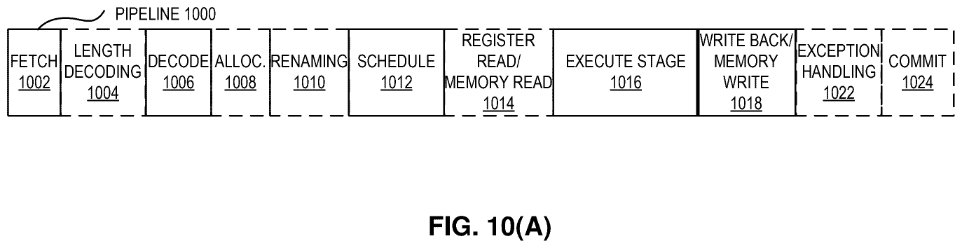

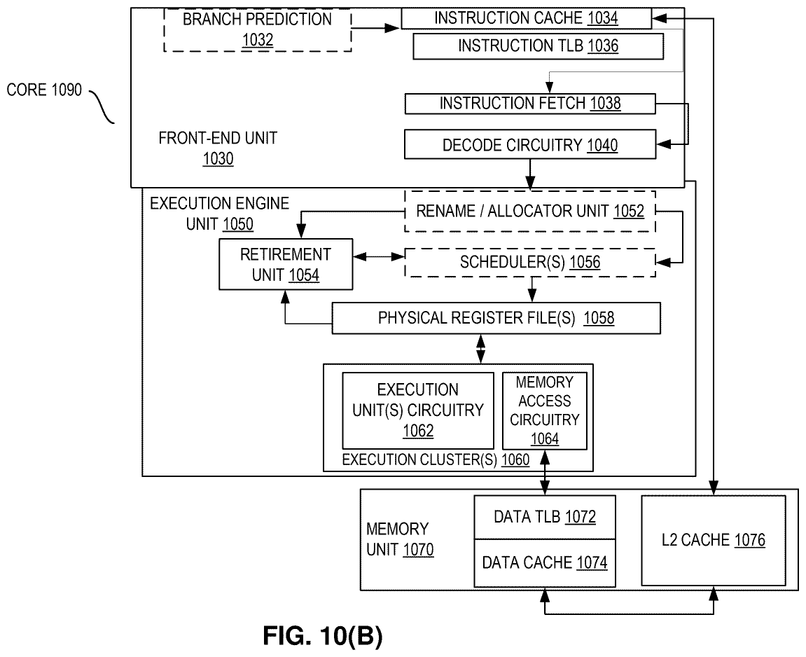

FIG. 10(A) is a block diagram illustrating both an example in-order pipeline and an example register renaming, out-of-order issue/execution pipeline according to examples. FIG. 10(B) is a block diagram illustrating both an example in-order architecture core and an example register renaming, out-of-order issue/execution architecture core to be included in a processor according to examples. The solid lined boxes in FIGS. 10(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10(A), a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1006 and the register read/memory read stage 1014 may be combined into one pipeline stage. In some examples, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 10(B) may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10(B) shows a processor core 1090 including front-end unit circuitry 1030 coupled to execution engine unit circuitry 1050, and both are coupled to memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, co-processor core, general purpose computing graphics processing unit (GPGPU) core, graphics core, or the like.

The front-end unit circuitry 1030 may include branch prediction circuitry 1032 coupled to instruction cache circuitry 1034, which is coupled to an instruction translation lookaside buffer (TLB) 1036, which is coupled to instruction fetch circuitry 1038, which is coupled to decode circuitry 1040. In some examples, the instruction cache circuitry 1034 is included in the memory unit circuitry 1070 rather than the front-end unit circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In some examples, the core 1090 includes a microcode ROM (not shown) or other medium that stores microcode for certain macroinstructions (e.g., in decode circuitry 1040 or otherwise within the front-end unit circuitry 1030). In some examples, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine unit circuitry 1050.

The execution engine unit circuitry 1050 includes the rename/allocator unit circuitry 1052 coupled to retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, address generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 1062 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster - and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to data cache circuitry 1074 coupled to level 2 (L2) cache circuitry 1076. In some examples, the memory access circuitry 1064 may include load unit circuitry, store address unit circuitry, and store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 1070. In some examples, the instruction cache 1034 and the data cache 1074 are combined into a single instruction and data cache (not shown) in L2 cache circuitry 1076, level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 1090 includes logic to support a packed data instruction set architecture extension (e.g., AVX1, AVX2, AVX512, AMX, etc.), thereby allowing the operations used by many multimedia applications to be performed using packed data.

### Example Execution Unit(s) Circuitry

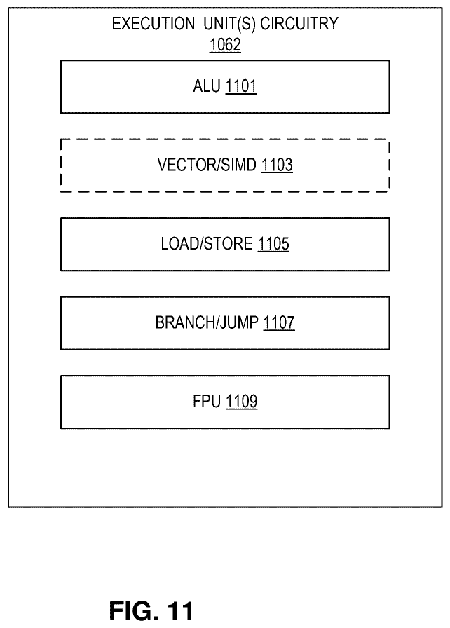

FIG. 11 illustrates examples of execution unit(s) circuitry, such as execution unit(s) circuitry 1062 of FIG. 10(B). As illustrated, execution unit(s) circuitry 1062 may include one or more ALU circuits 1101, optional vector/single instruction multiple data (SIMD) circuits 1103, load/store circuits 1105, branch/jump circuits 1107, and/or Floating-point unit (FPU) circuits 1109. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

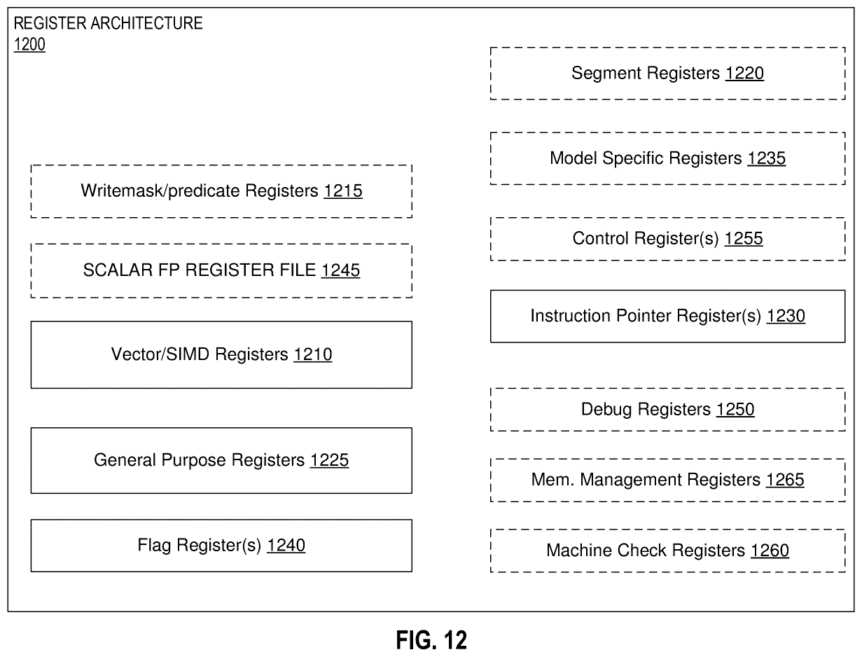

FIG. 12 is a block diagram of a register architecture 1200 according to some examples. As illustrated, the register architecture 1200 includes vector/SIMD registers 1210 that vary from 128-bit to 1,024 bits width. In some examples, the vector/SIMD registers 1210 are physically 512-bits and, depending upon the mapping, only some of the lower bits are used. For example, in some examples, the vector/SIMD registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register file 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Model specific registers or machine specific registers (MSRs) 1235 control and report on processor performance. Most MSRs 1235 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1260 consist of control, status, and error reporting MSRs that are used to detect and report on hardware errors. Control register(s) 1255 (e.g., CR0-CR4) determine the operating mode of a processor (e.g., processor 770, 780, 738, 715, and/or 800) and the characteristics of a currently executing task. In some examples, MSRs 1235 are a subset of control registers 1255.

One or more instruction pointer register(s) 1230 store an instruction pointer value. Debug registers 1250 control and allow for the monitoring of a processor or core's debugging operations.

Memory (mem) management registers 1265 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1200 may, for example, be used in register file/memory ISAB08, or physical register file(s) circuitry 1058.

### Instruction Set Architectures

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

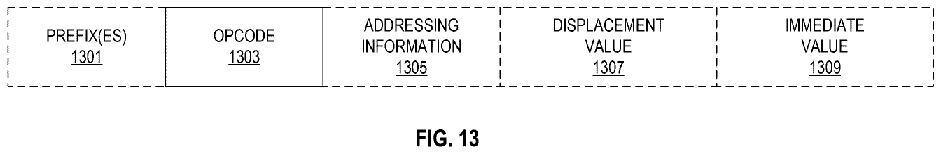

FIG. 13 illustrates examples of an instruction format. As illustrated, an instruction may include multiple components including, but not limited to, one or more fields for: one or more prefixes, an opcode, addressing information (e.g., register identifiers, memory addressing information, etc.), a displacement value, and/or an immediate value. Note that some instructions utilize some or all the fields of the format whereas others may only use the field for the opcode 1303. In some examples, the order illustrated is the order in which these fields are to be encoded, however, it should be appreciated that in other examples these fields may be encoded in a different order, combined, etc.

The prefix(es) f 1301, when used, modifies an instruction. In some examples, one or more prefixes are used to repeat string instructions (e.g., 0×F0, 0×F2, 0×F3, etc.), to provide section overrides (e.g., 0×2E, 0×36, 0×3E, 0×26, 0×64, 0×65, 0×2E, 0×3E, etc.), to perform bus lock operations, and/or to change operand (e.g., 0×66) and address sizes (e.g., 0×67). Certain instructions require a mandatory prefix (e.g., 0×66, 0×F2, 0×F3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1303 is used to at least partially define the operation to be performed upon a decoding of the instruction. In some examples, a primary opcode encoded in the opcode field 1303 is one, two, or three bytes in length. In other examples, a primary opcode can be a different length. An additional 3-bit opcode field is sometimes encoded in another field.

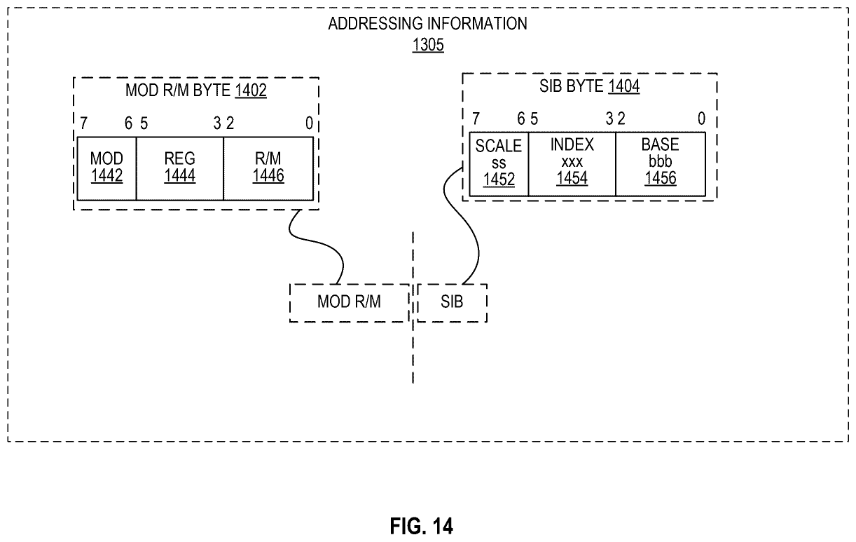

The addressing information field 1305 is used to address one or more operands of the instruction, such as a location in memory or one or more registers. FIG. 14 illustrates examples of the addressing information field 1305. In this illustration, an optional MOD R/M byte 1402 and an optional Scale, Index, Base (SIB) byte 1404 are shown. The MOD R/M byte 1402 and the SIB byte 1404 are used to encode up to two operands of an instruction, each of which is a direct register or effective memory address. Note that both of these fields are optional in that not all instructions include one or more of these fields. The MOD R/M byte 1402 includes a MOD field 1442, a register (reg) field 1444, and R/M field 1446.

The content of the MOD field 1442 distinguishes between memory access and non-memory access modes. In some examples, when the MOD field 1442 has a binary value of 11 (11b), a register-direct addressing mode is utilized, and otherwise a register-indirect addressing mode is used.

The register field 1444 may encode either the destination register operand or a source register operand or may encode an opcode extension and not be used to encode any instruction operand. The content of register field 1444, directly or through address generation, specifies the locations of a source or destination operand (either in a register or in memory). In some examples, the register field 1444 is supplemented with an additional bit from a prefix (e.g., prefix 1301) to allow for greater addressing.

The R/M field 1446 may be used to encode an instruction operand that references a memory address or may be used to encode either the destination register operand or a source register operand. Note the R/M field 1446 may be combined with the MOD field 1442 to dictate an addressing mode in some examples.

The SIB byte 1404 includes a scale field 1452, an index field 1454, and a base field 1456 to be used in the generation of an address. The scale field 1452 indicates a scaling factor. The index field 1454 specifies an index register to use. In some examples, the index field 1454 is supplemented with an additional bit from a prefix (e.g., prefix 1301) to allow for greater addressing. The base field 1456 specifies a base register to use. In some examples, the base field 1456 is supplemented with an additional bit from a prefix (e.g., prefix 1301) to allow for greater addressing. In practice, the content of the scale field 1452 allows for the scaling of the content of the index field 1454 for memory address generation (e.g., for address generation that uses 2scale*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1307 provides this value. Additionally, in some examples, a displacement factor usage is encoded in the MOD field of the addressing information field 1305 that indicates a compressed displacement scheme for which a displacement value is calculated and stored in the displacement field 1307.

In some examples, the immediate value field 1309 specifies an immediate value for the instruction. An immediate value may be encoded as a 1-byte value, a 2-byte value, a 4-byte value, etc.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Furthermore, the disclosure describes various examples in detail as noted above. Further examples are noted below.

Example 1. An apparatus comprising:
a receiver to receive a packet directed to a component on a die or a package containing the die; and
a logic circuit to evaluate attributes of the packet based on a number of criteria and a privilege level associated with the component that is a target of the packet, wherein the logic circuit is to:
   when the attributes of the packet meet the number of criteria, evaluate a packet privilege level to access the component to the privilege level associated with the component, and grant, substitute, or downgrade the packet privilege level; and
   when one or more attributes of the packet does not meet the number of criteria, reject the packet.

Example 2. The apparatus according to Example 1, wherein the logic circuit to further evaluate a source and a destination of the packet, and remap the source, the destination, or both the source and the destination to evaluate the attributes of the packet.

Example 3. The apparatus according to any one of Examples 1-2, wherein the logic circuit evaluates a size of the packet as one of the attributes and rejects the packet when the size of the packet is larger than a buffer which is to receive the packet.

Example 4. The apparatus according to any one of Examples 1-3, wherein the logic circuit evaluates an expanded header of the packet as one of the attributes and rejects the packet when the expanded header is unexpected or incorrect type for the packet.

Example 5. The apparatus according to any one of Examples 1-4, wherein the logic circuit evaluates an opcode of the packet to match a sent request of the packet and rejects the packet when the opcode does not match the sent request.

Example 6. The apparatus according to any one of Examples 1-5, wherein the logic circuit evaluates a reserved field of the packet and rejects the packet when the reserved field is not zero.

Example 7. The apparatus according to any one of Examples 1-6, wherein a type of packet privilege level is Security Attributes of Initiator (SAI) and in which the logic circuit to substitute access control to a different SAI for components that are to be protected.

Example 8. The apparatus according to any one of Examples 1-7, wherein a type of packet privilege level is Security Attributes of Initiator (SAI) and in which the logic circuit to downgrade access control to a lower SAI level for components that are to be protected.

Example 9. A method comprising:
receiving a packet directed to a component on a die or a package containing the die; and
evaluating attributes of the packet based on a number of criteria and a privilege level associated with the component that is a target of the packet, wherein:
   when the attributes of the packet meet the number of criteria, evaluating a packet privilege level to access the component to the privilege level associated with the component, and granting, substituting, or downgrading the packet privilege level; and
   when one or more attributes of the packet does not meet the number of criteria, rejecting the packet.

Example 10. The method according to Example 9 further comprising evaluating a source and a destination of the packet, and remapping the source, the destination, or both the source and the destination to evaluate the attributes of the packet.

Example 11. The method according to any one of Example 9-10 further comprising evaluating a size of the packet as one of the attributes and rejecting the packet when the size of the packet is larger than a buffer which is to receive the packet.

Example 12. The method according to any one of Examples 9-11 further comprising evaluating an expanded header of the packet as one of the attributes and rejecting the packet when the expanded header is unexpected or incorrect type for the packet.

Example 13. The method according to any one of Examples 9-12 further comprising evaluating an opcode of the packet to match a sent request of the packet and rejecting the packet when the opcode does not match the sent request.

Example 14. The method according to any one of Examples 9-13 further comprising evaluating a reserved field of the packet and rejecting the packet when the reserved field is not zero.

Example 15. The method according to any one of Examples 9-14, wherein a type of packet privilege level is Security Attributes of Initiator (SAI) and substituting access control to a different SAI for components that are to be protected.

Example 16. The method according to any one of Examples 9-15, wherein a type of packet privilege level is Security Attributes of Initiator (SAI) and downgrading access control to a lower SAI level for components that are to be protected.

Example 17. A system comprising:
a packet transfer fabric to transfer packets between a sender and a receiver coupled to the packet transfer fabric; and
a logic circuit at the receiver to obtain a packet directed to a component on a die or a package containing the die to evaluate attributes of the packet based on a number of criteria and a privilege level associated with the component that is a target of the packet, wherein the logic circuit is to:
   when the attributes of the packet meet the number of criteria, evaluate a packet privilege level to access the component to the privilege level associated with the component, and grant, substitute, or downgrade the packet privilege level; and
   when one or more attributes of the packet does not meet the number of criteria, reject the packet.

Example 18. The system according to Example 17, wherein the logic circuit to further evaluate a source and a destination of the packet, and remap the source, the destination, or both the source and the destination to evaluate the attributes of the packet.

Example 19. The system according to any one of Examples 17-18, wherein the logic circuit is further to:
evaluate a size of the packet as one of the attributes and rejects the packet when the size of the packet is larger than a buffer which is to receive the packet;
evaluate an expanded header of the packet as one of the attributes and rejects the packet when the expanded header is unexpected or incorrect type for the packet;
evaluate an opcode of the packet to match a sent request of the packet and rejects the packet when the opcode does not match the sent request; and
evaluate a reserved field of the packet and rejects the packet when the reserved field is not zero.

Example 20. The system according to any one of Examples 17-19, wherein a type of packet privilege level is Security Attributes of Initiator (SAI) and in which the logic circuit to downgrade the SAI to “DEVICE_UNTRUSTED_SAI” to identify potential threat of the packet to components that are to be protected.

What is claimed is:

1. An apparatus comprising:
a receiver to receive a packet directed to a component on a die or a package containing the die; and
a logic circuit to evaluate attributes of the packet based on a number of criteria and a privilege level associated with the component that is a target of the packet, wherein the logic circuit is to:
when the attributes of the packet meet the number of criteria, evaluate a packet privilege level to access the component to the privilege level associated with the component, and grant, substitute, or downgrade the packet privilege level; and
when one or more attributes of the packet does not meet the number of criteria, reject the packet.

2. The apparatus according to claim 1, wherein the logic circuit to further evaluate a source and a destination of the packet, and remap the source, the destination, or both the source and the destination to evaluate the attributes of the packet.

3. The apparatus according to claim 1, wherein the logic circuit evaluates a size of the packet as one of the attributes and rejects the packet when the size of the packet is larger than a buffer which is to receive the packet.

4. The apparatus according to claim 1, wherein the logic circuit evaluates an expanded header of the packet as one of the attributes and rejects the packet when the expanded header is unexpected or incorrect type for the packet.

5. The apparatus according to claim 1, wherein the logic circuit evaluates an opcode of the packet to match a sent request of the packet and rejects the packet when the opcode does not match the sent request.

6. The apparatus according to claim 1, wherein the logic circuit evaluates a reserved field of the packet and rejects the packet when the reserved field is not zero.

7. The apparatus according to claim 1, wherein a type of packet privilege level is Security Attributes of Initiator (SAI) and in which the logic circuit to substitute access control to a different SAI for components that are to be protected.

8. The apparatus according to claim 1, wherein a type of packet privilege level is Security Attributes of Initiator (SAI) and in which the logic circuit to downgrade access control to a lower SAI level for components that are to be protected.

9. A method comprising:
receiving a packet directed to a component on a die or a package containing the die; and
evaluating attributes of the packet based on a number of criteria and a privilege level associated with the component that is a target of the packet, wherein:
when the attributes of the packet meet the number of criteria, evaluating a packet privilege level to access the component to the privilege level associated with the component, and granting, substituting, or downgrading the packet privilege level; and
when one or more attributes of the packet does not meet the number of criteria, rejecting the packet.

10. The method according to claim 9 further comprising evaluating a source and a destination of the packet, and remapping the source, the destination, or both the source and the destination to evaluate the attributes of the packet.

11. The method according to claim 9 further comprising evaluating a size of the packet as one of the attributes and rejecting the packet when the size of the packet is larger than a buffer which is to receive the packet.

12. The method according to claim 9 further comprising evaluating an expanded header of the packet as one of the attributes and rejecting the packet when the expanded header is unexpected or incorrect type for the packet.

13. The method according to claim 9 further comprising evaluating an opcode of the packet to match a sent request of the packet and rejecting the packet when the opcode does not match the sent request.

14. The method according to claim 9 further comprising evaluating a reserved field of the packet and rejecting the packet when the reserved field is not zero.

15. The method according to claim 9, wherein a type of packet privilege level is Security Attributes of Initiator (SAI) and substituting access control to a different SAI for components that are to be protected.

16. The method according to claim 9, wherein a type of packet privilege level is Security Attributes of Initiator (SAI) and downgrading access control to a lower SAI level for components that are to be protected.

17. A system comprising:
a packet transfer fabric to transfer packets between a sender and a receiver coupled to the packet transfer fabric; and
a logic circuit at the receiver to obtain a packet directed to a component on a die or a package containing the die to evaluate attributes of the packet based on a number of criteria and a privilege level associated with the component that is a target of the packet, wherein the logic circuit is to:
when the attributes of the packet meet the number of criteria, evaluate a packet privilege level to access the component to the privilege level associated with the component, and grant, substitute, or downgrade the packet privilege level; and
when one or more attributes of the packet does not meet the number of criteria, reject the packet.

18. The system according to claim 17, wherein the logic circuit to further evaluate a source and a destination of the packet, and remap the source, the destination, or both the source and the destination to evaluate the attributes of the packet.

19. The system according to claim 18, wherein the logic circuit is further to:
evaluate a size of the packet as one of the attributes and rejects the packet when the size of the packet is larger than a buffer which is to receive the packet;
evaluate an expanded header of the packet as one of the attributes and rejects the packet when the expanded header is unexpected or incorrect type for the packet;
evaluate an opcode of the packet to match a sent request of the packet and rejects the packet when the opcode does not match the sent request; and
evaluate a reserved field of the packet and rejects the packet when the reserved field is not zero.

20. The system according to claim 17, wherein a type of packet privilege level is Security Attributes of Initiator (SAI) and in which the logic circuit to downgrade the SAI to “DEVICE_UNTRUSTED_SAI” to identify potential threat of the packet to components that are to be protected.
